(19) United States
(12) Patent Application Publication
(10) Pub. No.: US 2021/0150258 A1
(43) Pub. Date: May 20, 2021

(54) APPARATUS, SYSTEM, AND METHOD OF PROVIDING IN-SITU IMAGE-BASED RECOGNITION OF GEMSTONE CHARACTERISTICS

(71) Applicant: Josh Lehman, Las Vegas, NV (US)

(72) Inventor: Josh Lehman, Las Vegas, NV (US)

(21) Appl. No.: 17/080,420

(22) Filed: Oct. 26, 2020

Related U.S. Application Data
(60) Provisional application No. 62/925,467, filed on Oct. 24, 2019.

(51) Int. Cl. G06K 9/62; H04N 5/247; H04N 5/225; G06K 9/46; G06K 9/20; G01N 21/87; G01N 21/3563

(52) U.S. Cl. CPC G06K 9/6215; H04N 5/247; H04N 5/2256; G06K 9/6217; G01N 2201/061; G06K 9/4661; G06K 9/209; G01N 21/87; G01N 21/3563; G06K 9/4652

(57) ABSTRACT

An in-situ gemstone characteristic analysis system, apparatus and method. Included are an in-situ rig comprising a plurality of movable camera sensors, a plurality of stimulus dispensers, and a plurality of environmental condition dispensers; a first input remote from the in-situ rig for receiving output from the camera sensors responsive to applications to a gemstone in the in-situ rig of at least the stimulus and the environmental conditions; a comparator communicative with the first input and having accessible thereto a plurality of gemstone characteristics resultant from substantially similar ones of the stimulus and the environmental conditions, and capable of comparing the output from the camera sensors to the plurality of gemstone characteristics and finding a match, under control from at least one computing processor applying a plurality of machine learning rules; and a match output in a case of the match being within a predetermined threshold.

### CROSS-REFERENCE TO RELATED APPLICATIONS

This application claims the benefit of priority to U.S. Prov. App. No. 62/925,467, filed Oct. 24, 2019, the entirety of which is incorporated by reference as if set forth herein.

### BACKGROUND

### Field of the Disclosure

The disclosure relates generally to image recognition, and, more particularly, to an apparatus, system, and method of providing hardware and software for in-situ image-based recognition of characteristics of a gemstone.

### Background of the Disclosure

Historically, there was no agreed-upon standard by which gemstones, and particularly diamonds, were judged. GIA developed the current globally accepted standard for describing diamonds: Color, Clarity, Cut and Carat Weight. However, using current methods, the only way to have gemstones certified by GAI (or equivalent bodies) under this globally accepted standard is to send the gemstone to GAI for grading. Obviously, there is substantial risk inherent in such a system, and consequently many if not most gemstones currently go ungraded.

Two of the aforementioned “4C's”, namely cut and carat weight, can be assessed readily in the field, such as by a certified jeweler. However, two other of the “4C's”, namely color and clarity, are presently nearly impossible to assess using data gained locally.

Diamonds are valued by how closely they approach colorlessness—the less color, the higher their respective value. Most diamonds found in jewelry stores run from colorless to near-colorless, with slight hints of yellow or brown. GIA's color-grading scale begins with the letter D, representing colorless, and continues with increasing presence of color to the letter Z, or light yellow or brown. Each letter grade has a clearly defined range of color appearance. Diamonds are color-graded by GAI by comparing them to stones of known color under controlled lighting and precise viewing conditions. Indeed, many of these color distinctions are sufficiently subtle so as to be invisible to the untrained eye.

Clarity refers to the extent of the absence of inclusions and blemishes in or on a diamond. The GIA Clarity Scale contains 11 grades, with most diamonds falling into the VS (very slightly included) or SI (slightly included) categories. In determining a clarity grade, GIA considers the size, nature, position, color or relief, and quantity of clarity characteristics visible under 10× magnification.

In light of the foregoing, a need exists for in-situ data capture enabling a certification from a remote body, such as GAI, regarding gemstone characteristics, without the need to physically send those gemstones remotely.

### SUMMARY OF THE DISCLOSURE

The disclosure includes an in-situ gemstone characteristic analysis system, apparatus and method. The embodiments include an in-situ rig comprising a plurality of movable camera sensors, a plurality of stimulus dispensers, and a plurality of environmental condition dispensers; a first input remote from the in-situ rig for receiving output from the camera sensors responsive to applications to a gemstone in the in-situ rig of at least the stimulus and the environmental conditions; a comparator communicative with the first input and having accessible thereto a plurality of gemstone characteristics resultant from substantially similar ones of the stimulus and the environmental conditions, and capable of comparing the output from the camera sensors to the plurality of gemstone characteristics and finding a match, under control from at least one computing processor applying a plurality of machine learning rules; and a match output in a case of the match being within a predetermined threshold.

### BRIEF DESCRIPTION OF THE DRAWINGS

The disclosure is illustrated by way of example and not limitation in the accompanying drawings, in which like references may indicate similar elements, and in which:

FIG. 1 is an illustration of an aspect of the embodiments;

FIG. 2A is an illustration of aspects of the embodiments;

FIG. 2B is an illustration of aspects of the embodiments;

FIG. 2C is an illustration of aspects of the embodiments;

FIG. 3A is an illustration of an aspect of the embodiments;

FIG. 3B is an illustration of an aspect of the embodiments;

FIG. 3C is an illustration of an aspect of the embodiments;

FIG. 3D is an illustration of an aspect of the embodiments;

FIG. 4A is an illustration of an aspect of the embodiments;

FIG. 4B is an illustration of an aspect of the embodiments;

FIG. 4C is an illustration of an aspect of the embodiments;

FIG. 5A is an illustration of an aspect of the embodiments;

FIG. 5B is an illustration of an aspect of the embodiments;

FIG. 5C is an illustration of an aspect of the embodiments;

FIG. 6 is an illustration of aspects of the embodiments; and

FIG. 7 is an illustration of a processing system.

### DETAILED DESCRIPTION

The figures and descriptions provided herein may have been simplified to illustrate aspects that are relevant for a clear understanding of the herein described devices, systems, and methods, while eliminating, for the purpose of clarity, other aspects that may be found in typical similar devices, systems, and methods. Those of ordinary skill may recognize that other elements and/or operations may be desirable and/or necessary to implement the devices, systems, and methods described herein. But because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

The terminology used herein is for the purpose of describing particular example embodiments only and is not intended to be limiting. For example, as used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc., may be used herein to describe various elements, components, regions, layers and/or sections, these elements, components, regions, layers and/or sections should not be limited by these terms. These terms may be only used to distinguish one element, component, region, layer or section from another element, component, region, layer or section. That is, terms such as “first,” “second,” and other numerical terms, when used herein, do not imply a sequence or order unless clearly indicated by the context. Thus, a first element, component, region, layer or section discussed below could be termed a second element, component, region, layer or section without departing from the teachings of the exemplary embodiments.

Processor-implemented modules, systems and methods of use are disclosed herein that may provide access to and transformation of a plurality of types of digital content, including but not limited to video, image, text, audio, metadata, algorithms, interactive and document content, and which track, deliver, manipulate, transform, transceive and report the accessed content. Described embodiments of these modules, systems and methods are intended to be exemplary and not limiting. As such, it is contemplated that the herein described systems and methods may be adapted and may be extended to provide enhancements and/or additions to the exemplary modules, systems and methods described. The disclosure is thus intended to include all such extensions.

Thereby, the embodiments enable collecting, comparing and processing images, in-situ, to assess characteristics of gemstones. More specifically, the disclosed solution may also provide controls regarding enrollment of images for comparison to data later obtained on-site, such as using the disclosed enrollment photo rig, resulting in optimal characteristic matching results. Comparative parameters may be adjusted during “break-in” of a given rig for use in-situ, to thereby yield exceptional results.

A score within a given threshold may determine a match of an in-situ series of images to enrolled images. Additionally and alternatively, an in-situ rig may provide a controlled environment (i.e., distance, lighting, etc.) which may allow for characteristics evidenced by a gemstone in the images, such as reflectivity, light conductivity, refraction, responsiveness to applications of different light intensities, colors, and so on, and/or response by the gemstone in the images to the application of heat, radiation, light, and the like, to be indicative of the characteristics of the gemstone subjected to the in-situ rig.

It should also be noted that errors in identification increase with database size. Thus, the disclosed LM module and rules engine may infer certain information, such as based upon enrolled data, in order to limit the size of the comparative database applied by a comparator.

Yet further, in training the disclosed ML model, considerations are made as to forming the training set, the size of the final vectors, the metric used to compare the results, and any loss function. For example, the disclosed ML model approach may be based on several different images per characteristic.

One of the most important issues, i.e., confusion factors, which affect the identification accuracy of 2D characteristics recognition systems is the change in the position with respect to the camera. This difficulty in 2D recognition may be remedied by the use of 3D recognition; however, one of the biggest differences between 2D and 3D characteristics recognition is the need for substantial additional data acquisition processes and devices for 3D, preferably without a significant increase in processing time.

In particular, 3D characteristics recognition may require specialized hardware, particularly if done in-situ. 3D data acquisition methods for specific characteristics in-situ may be active or passive. Moreover, 3D data acquisition may be keyed in the embodiments to particular, detectable features responsive to stimuli provided by the dedicated hardware in-situ, such as particular lighting (intensity, color(s), etc.), temperatures, etc. which may serve as the base points for the 3D analysis of a comparison dataset (i.e., comparison characteristics of gemstones imaged under the same circumstances, or expected responsive characteristics to the provided stimuli) when applied to the acquired real time data gained in-situ.

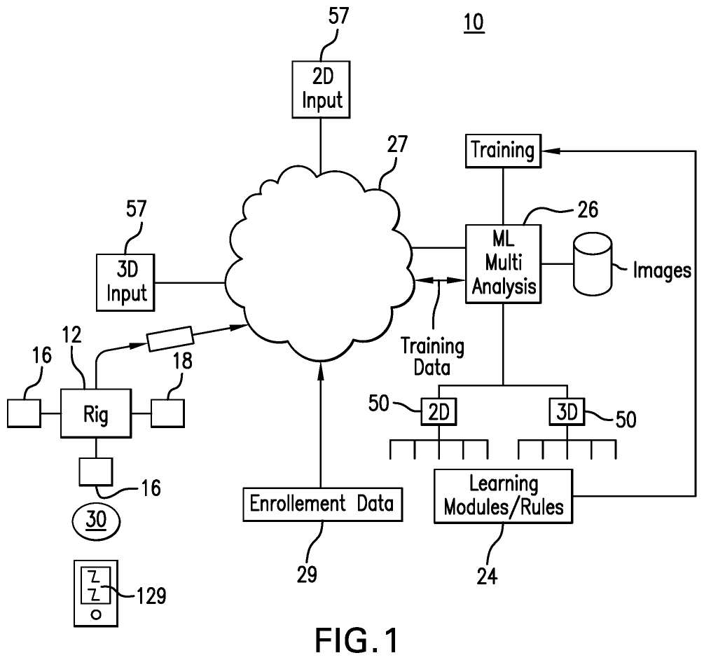

A multi-level in-situ gemstone analysis system 10 is illustrated in the embodiment of FIG. 1. As shown, the system may include an in-situ image capture rig system 12, which includes cameras/sensors 14 to capture images and/or response to a stimulus 16 (which may be provided by the rig, or which may comprise separate hardware from the rig), hardware and software to provide the stimulus 16, and/or hardware and software (such as lighting) to create particular environmental conditions 18 under which the cameras 14 capture the images 20.

Additionally included in the analysis system 10 may be a plurality of learned rules 24 (which may be learned/modified by machine learning 26 based on the propriety of conclusions drawn) which allow for the assessment of characteristics of a gemstone 30 subjected in-situ to the capture system 12 based on comparison to enrollment data 29. The learned rules may be local to the capture rig 12, or may be remote therefrom, such as being available over the cloud 27 to one or more GUIs 12a locally associated with the capture system 12.

As indicated, the rules 24 may assess characteristics of the gemstone 30 based on either a response to in-situ stimuli 16 (as compared by comparator 40 to stored responses of gemstones having known responses to the same stimuli, wherein comparator may be local or remote to capture system 12), or based on comparison of images 20 captured by rig 14 to images of gemstones having known characteristics upon exposure to the same environmental conditions 18 under which images 20 are captured. Of course, it will be understood that this analysis may occur locally, or may occur remotely, such as at GAI; and that the results of the analysis may be conveyed, particularly if the analysis is done remotely, by any known methodology, including mailing from the remote entity of a certification, or the electronic sending from the remote entity of a secure certification.

In light of the foregoing, the illustration includes a training aspect to train a rules model 24 that incorporates a 2D and a 3D image analysis 50. The 2D/3D image analyses, as well as the existing images of known gemstones and comparative gemstone characteristics 29, may be available, such as over cloud 27, from within system 10, or from third party data providers 57, such as GAI.

For example, enrolled comparison data for the 3D comparison may occur via a dedicated 3D scan device used for the enrollment to provide the data for later characteristic identification using the same (or a similar subjected to software differential accounting) rig. Therefore, the disclosed learning model may use techniques to compare a 3D image to a 2D image or characteristics, or a 2D image to a 3D image or characteristics, and/or to engage in the multi-level analysis discussed herein.

In short, data acquisition, either for the comparative/enrollment data or for the characteristics identification data, may assess that the hardware in-situ must take several snapshots that represent the individual gemstone from particular angles to enable a comparison. Such may be the case if the in-situ rig has a limited number, such as one, of the cameras when compared to an enrollment rig (or enrollment comparison characteristics. This can allow either an overlay of the snapshots to form a 3D comparative image akin to an enrolled 3D model for comparison, or can result in selection of a given best-fit 2D image or images in the variety of enrolled captures for a comparison (such as using a position-estimation algorithm applied to each of the 2D images).

In each such case, the best angle may be used to compare a pair of images, and the comparison may be defaulted to 2D methods, such as to limit processing power needed. That is, 3D comparison/enrollment data and/or 3D identification capture data may be devolved into 2D data.

Moreover, the foregoing algorithm may be employed iteratively. That is, an initialization point may be given; and thereafter, each live position estimation may be iteratively performed using the immediately previous frame position or characteristic values. This additionally helps to avoid noisy estimations of data values.

The camera rig system may be communicatively associated with a high quality network suitable for comparing, and with one or more user interfaces (UI) that may be local and remote. In short, the comparison, either to images or to characteristics under the same conditions, may also occur locally or remotely to the in-situ rig/camera/cameras.

The UI may be presented, at least in part, by a camera server, and the UI may provide, in part, control over imaging conditions, focus, zoom, and quality. The camera server may additionally have associated therewith an API to allow for the foregoing aspects. The UI may also provide thin or thick client access to the comparative data (which may also have been enrolled via one or more remote enrollment rigs).

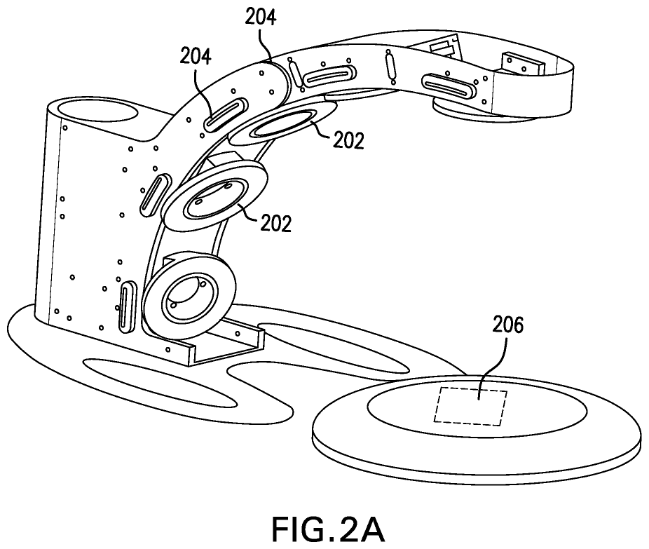

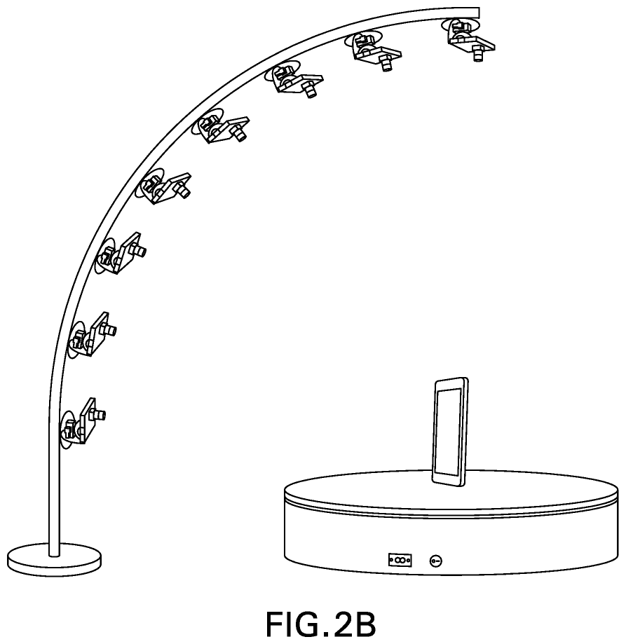

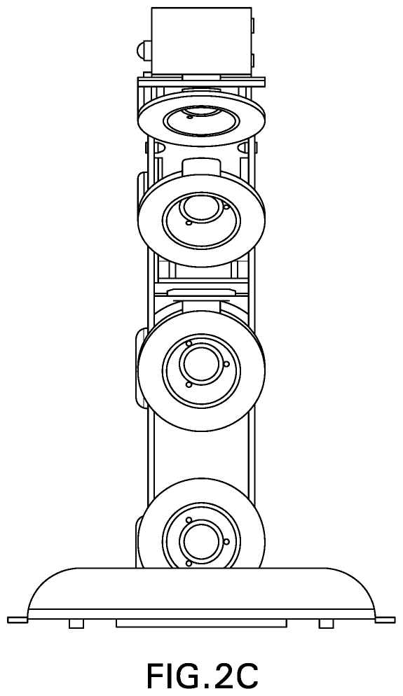

In order to provide for the foregoing, FIGS. 2A, 2B and 2C illustrate an image rig that allows for pictures of varying size angles from a plurality of cameras. Of note, the camera and rig illustrated may be locally controlled, either automatically or manually, or may be controlled remotely, such as via a web or mobile application, or administratively controlled by a provider of a subscription service which enables access to enrolled images or characteristics response listings for comparison to enable gemstone classification in-situ, as discussed throughout. Of note, the camera(s) 202 illustrated may be manually or automatically focused/moved 204 in the correct direction or directions, and focus may be controlled locally or remotely as discussed throughout.

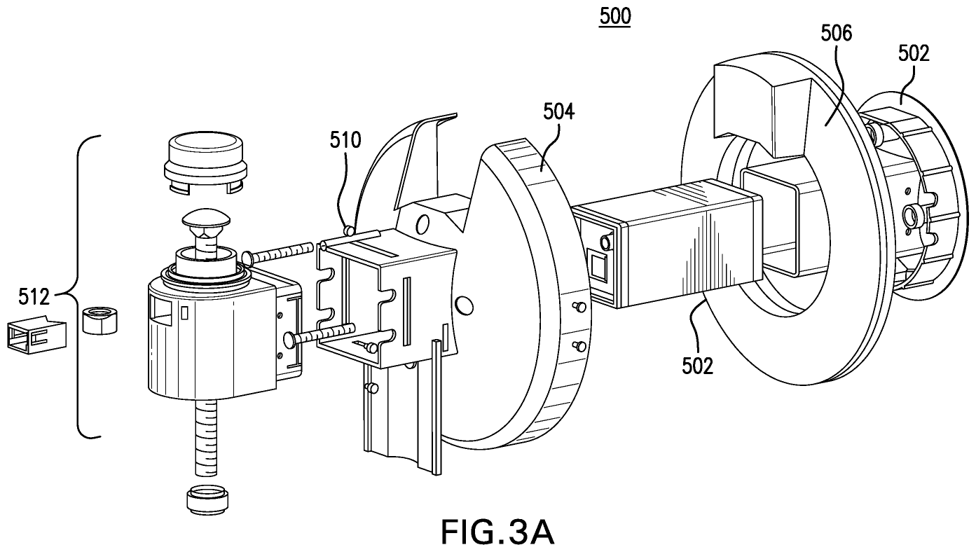

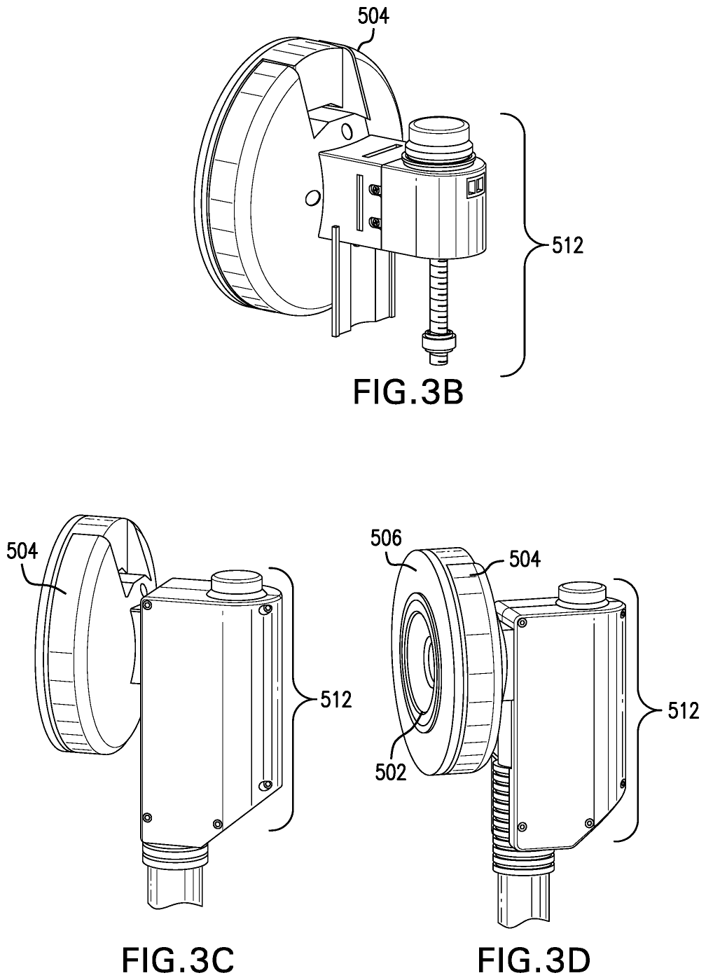

FIGS. 3A, 3B, 3C, and 3D illustrate an individual camera that may be associated with the disclosed rig. Illustrated are a camera aspect, which may be embedded within a housing that may also include lighting, such as LED ring lighting, and a rear camera housing that physically associates with a (manually or automatically) adjustable mount. Moreover, the lighting, as used herein, may also refer to variable spectrum of the light provided, variable color of the light provided, variable intensity of the light provided, or other radiative features provided toward the gemstone and sensed by the camera/sensor, such as heat, microwaves, etc.

The adjustable mount of the illustrated camera/sensor may allow for rotational adjustment of camera angle, and a height adjustment of the camera. Also included may be power and signal lines running to at least the camera aspect, the lighting, and the adjustable mount. FIG. 3A illustrates the referenced camera in breakout view, and FIGS. 3B-3D illustrate the assembled camera assembly. In preferred embodiments, this camera would be one of several associated with a rig in-situ where the gemstone or gemstones is/are to be characterized.

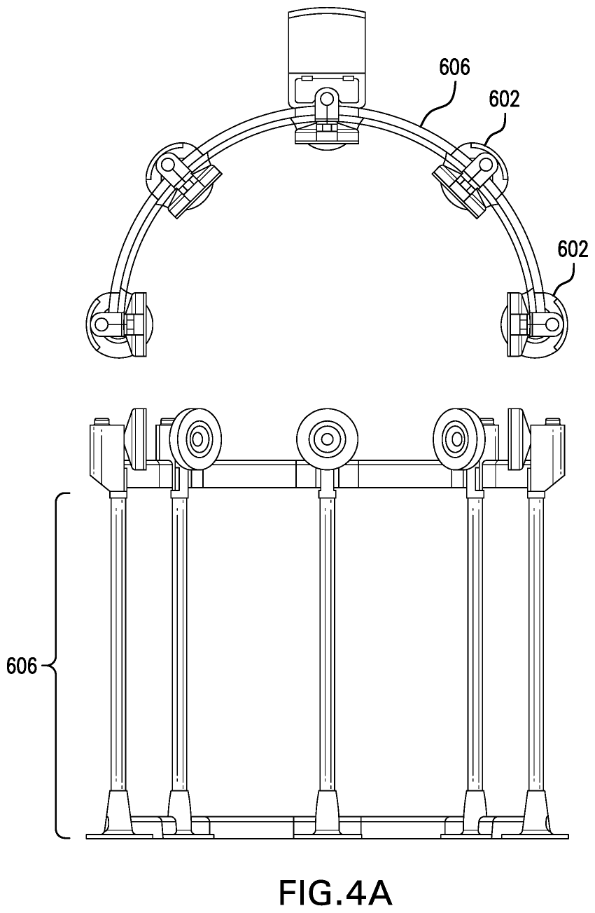

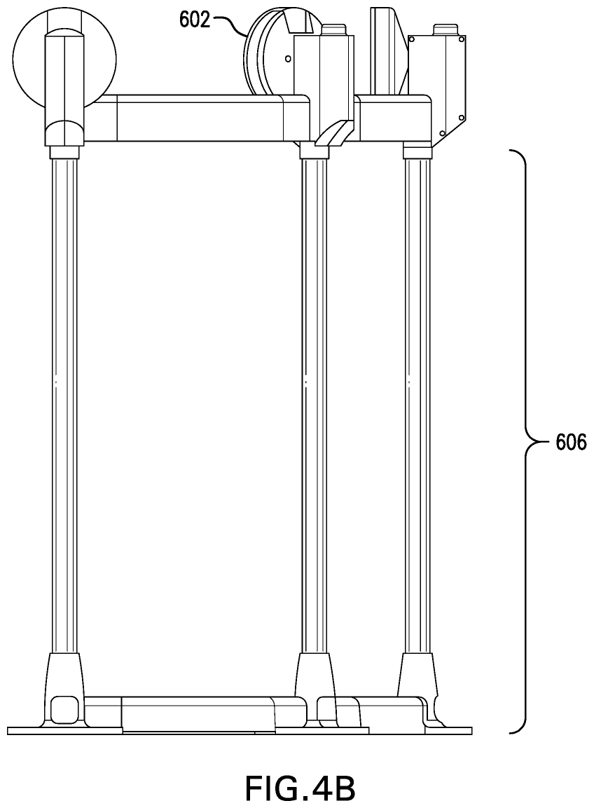

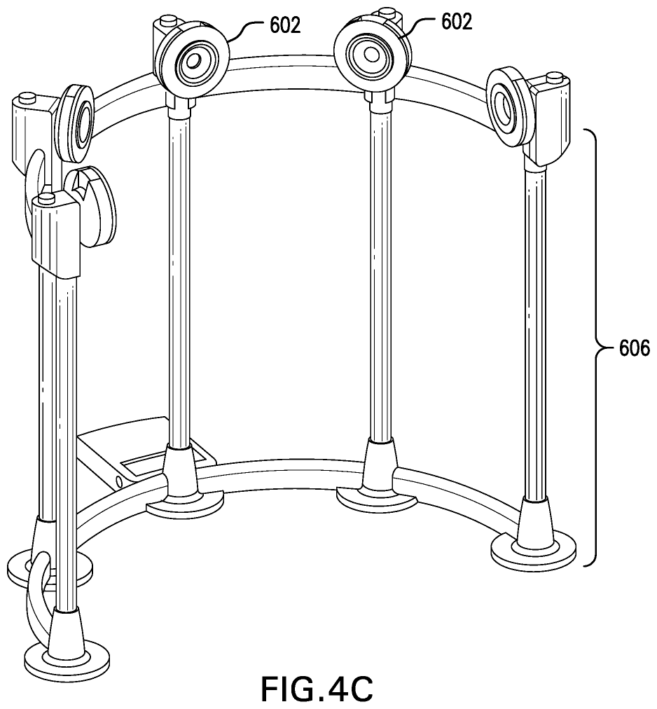

FIGS. 4A, 4B, and 4C illustrate the cameras illustratively provided in FIG. 3 connectively associated with an additional exemplary camera rig. The camera rig may provide interconnection of the individual cameras to the aforementioned camera server, to the GUI, and/or to the network. The imaged subject may be placed at the approximate center point of the field of view of the cameras illustratively shown. The camera rig may be sized and shaped, and/or suitable to be broken down readily into pieces, so as to be conveniently portable for in-situ use at differing locations.

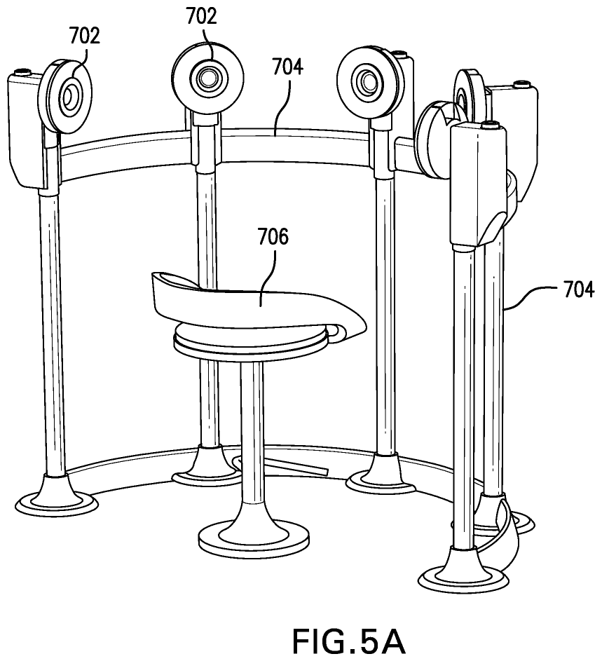

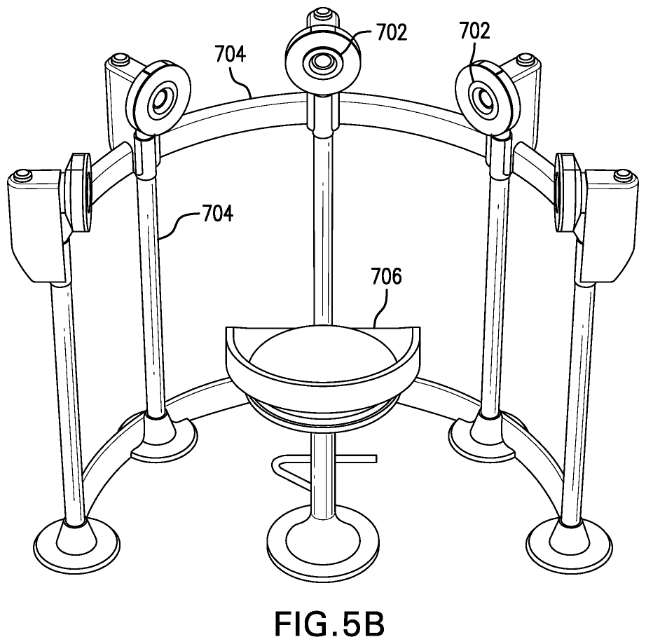

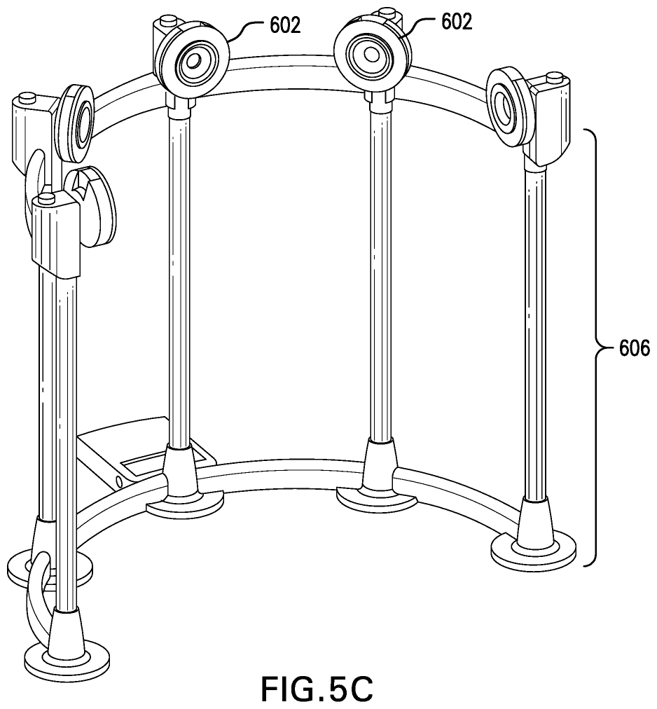

FIGS. 5A, 5B, and 5C illustrate an assembled plurality of cameras atop a rig, and the image subject having a location at or near the centerpoint of the combined fields of view of the plurality of cameras. Of note, ones of the cameras may serve to irradiate the subject for characteristics assessment by those or other ones of the cameras acting as sensors to sense, for example, reflection, refraction, spectral breakdown, etc. or the irradiation provided. Additionally and alternatively, the cameras may solely take images for comparison to stored enrolled images that represent characteristics categorization. Further illustrated with particularity in FIG. 5C is an association of the camera rig, and hence of the individual cameras, with a camera server. The adjustable height and lighting from the camera rig allow for maximum detail extraction and optimal lighting for different subjects.

Data processing may be further reduced by manually or automatically filtering based on known characteristics. Filtering characteristics may include cut, mounting, karat weight, and so on. Thus, a further method of reducing the size of the identification set is through group characteristics, i.e., hierarchical categorization.

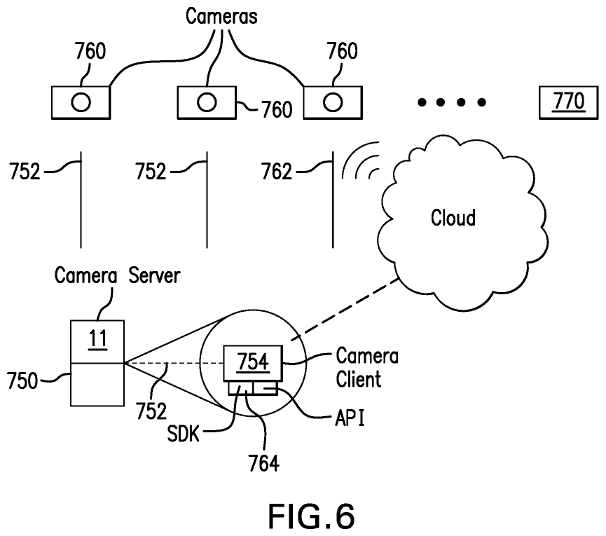

As referenced above and as illustrated in FIG. 6, a camera server may obtain (or receive, such as from a third party feed in the cloud) comparative image data and/or characteristics classification data, to allow for the comparison disclosed throughout. As such, a software component “camera client”, such as a C++ component, may handle low level communication with a specific camera or cameras and/or data feeds. An SDK may offer an open source framework for image processing.

The server (or servers) acts as an intermediate discovery node between web clients and camera clients, allowing them to establish a real time communication for commanding cameras and obtaining and comparing images (locally or remotely), either with characteristics data or with enrolled images indicative of characteristics, such as, particularly, gemstone color and clarity. All generated data from cameras or third party images may be available through an HTTP simple interface.

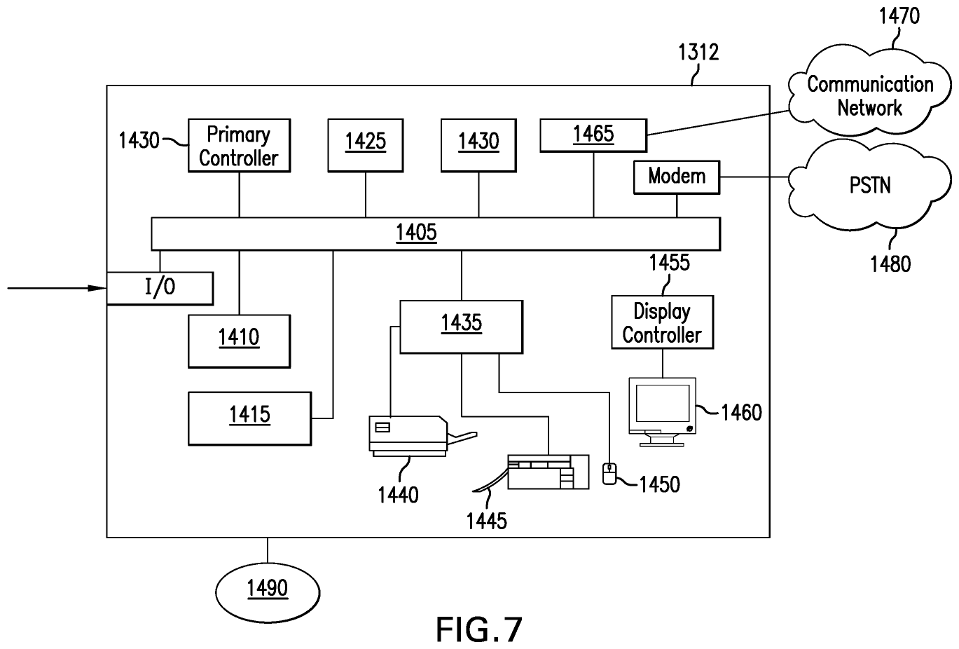

FIG. 7 depicts an exemplary computer processing system 1312 for use in association with the embodiments, by way of non-limiting example. Processing system 1312 is capable of executing software, such as an operating system (OS), applications, user interface, and/or one or more other computing algorithms/applications 1490, such as the recipes, models, programs and subprograms discussed herein. The operation of exemplary processing system 1312 is controlled primarily by these computer readable instructions/code 1490, such as instructions stored in a computer readable storage medium, such as hard disk drive (HDD) 1415, optical disk (not shown) such as a CD or DVD, solid state drive (not shown) such as a USB “thumb drive,” or the like. Such instructions may be executed within central processing unit (CPU) 1410 to cause system 1312 to perform the disclosed operations, comparisons and calculations. In many known computer servers, workstations, personal computers, and the like, CPU 1410 is implemented in an integrated circuit called a processor.

It is appreciated that, although exemplary processing system 1312 is shown to comprise a single CPU 1410, such description is merely illustrative, as processing system 1312 may comprise a plurality of CPUs 1410. Additionally, system 1312 may exploit the resources of remote CPUs (not shown) through communications network 1470 or some other data communications means 1480, as discussed throughout.

In operation, CPU 1410 fetches, decodes, and executes instructions from a computer readable storage medium, such as HDD 1415. Such instructions may be included in software 1490. Information, such as computer instructions and other computer readable data, is transferred between components of system 1312 via the system's main data-transfer path. The main data-transfer path may use a system bus architecture 1405, although other computer architectures (not shown) can be used.

Memory devices coupled to system bus 1405 may include random access memory (RAM) 1425 and/or read only memory (ROM) 1430, by way of example. Such memories include circuitry that allows information to be stored and retrieved. ROMs 1430 generally contain stored data that cannot be modified. Data stored in RAM 1425 can be read or changed by CPU 1410 or other hardware devices. Access to RAM 1425 and/or ROM 1430 may be controlled by memory controller 1420.

In addition, processing system 1312 may contain peripheral communications controller and bus 1435, which is responsible for communicating instructions from CPU 1410 to, and/or receiving data from, peripherals, such as peripherals 1440, 1445, and 1450, which may include printers, keyboards, and/or the operator interaction elements on a mobile device as discussed herein throughout. An example of a peripheral bus is the Peripheral Component Interconnect (PCI) bus that is well known in the pertinent art.

Operator display 1460, which is controlled by display controller 1455, may be used to display visual output and/or presentation data generated by or at the request of processing system 1312, such as responsive to operation of the aforementioned computing programs/applications 1490. Such visual output may include text, graphics, animated graphics, and/or video, for example. Display 1460 may be implemented with a CRT-based video display, an LCD or LED-based display, a gas plasma-based flat-panel display, a touch-panel display, or the like. Display controller 1455 includes electronic components required to generate a video signal that is sent to display 1460.

Further, processing system 1312 may contain network adapter 1465 which may be used to couple to external communication network 1470, which may include or provide access to the Internet, an intranet, an extranet, or the like. Communications network 1470 may provide access for processing system 1312 with means of communicating and transferring software and information electronically. Additionally, communications network 1470 may provide for distributed processing, which involves several computers and the sharing of workloads or cooperative efforts in performing a task, as discussed above. Network adaptor 1465 may communicate to and from network 1470 using any available wired or wireless technologies. Such technologies may include, by way of non-limiting example, cellular, Wi-Fi, Bluetooth, infrared, or the like.

In the foregoing Detailed Description, it can be seen that various features are grouped together in a single embodiment for the purpose of clarity and brevity of the disclosure. This method of disclosure is not to be interpreted as reflecting an intention that the embodiments require more features than are expressly recited herein. Rather, the disclosure is to encompass all variations and modifications to the disclosed embodiments that would be understood to the skilled artisan in light of the disclosure.

What is claimed is:

1. An in-situ gemstone characteristic analysis system, comprising:
an in-situ rig comprising a plurality of movable camera sensors, a plurality of stimulus dispensers, and a plurality of environmental condition dispensers;
a first input remote from the in-situ rig for receiving output from the camera sensors responsive to applications to a gemstone in the in-situ rig of at least the stimulus and the environmental conditions;
a comparator communicative with the first input and having accessible thereto a plurality of gemstone characteristics resultant from substantially similar ones of the stimulus and the environmental conditions, and capable of comparing the output from the camera sensors to the plurality of gemstone characteristics and finding a match, under control from at least one computing processor applying a plurality of machine learning rules; and
a match output in a case of the match being within a predetermined threshold.

2. The analysis system of claim 1, wherein the plurality of movable camera sensors is suitable for on-site assembly.

3. The analysis system of claim 1, wherein the plurality of movable camera sensors is pre-assembled.

4. The analysis system of claim 1, wherein the plurality of stimulus dispensers includes an infrared stimulus.

5. The analysis system of claim 1, wherein the plurality of stimulus dispensers includes a plurality of varying light dispensers.

6. The analysis system of claim 1, wherein the plurality of environmental condition dispensers modify in-situ conditions of the in-situ rig to match the environmental conditions accessible to the comparator.

7. The analysis system of claim 1, wherein the machine learning rules comprise a baseline training.

8. The analysis system of claim 1, wherein the gemstone characteristics include at least color.

9. The analysis system of claim 1, wherein the gemstone characteristics include at least clarity.

10. The analysis system of claim 1, wherein the match output is provided to and is accessible from a cloud-based storage.
